(19) United States
(12) Patent Application Publication
(10) Pub. No.: US 2009/0195554 A1
(43) Pub. Date: Aug. 6, 2009

(54) Display Device

(75) Inventor: Chih-Lin Hu, Tainan City (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan County (TW)

(21) Appl. No.: 12/360,854

(22) Filed: Jan. 28, 2009

(30) Foreign Application Priority Data
Feb. 1, 2008 (TW) 097103988

(51) Int. Cl. G09G 5/00

(52) U.S. Cl. 345/619

(57) ABSTRACT

A display device and a displaying method implemented by the same are provided. The display device includes a first memory module, an identification device, a display screen, and a processing module. The processing module is electrically connected to the first memory module, the identification device, and the display screen. The identification device is provided for identifying a personal feature and generating a personal identity code. The processing module outputs multimedia information stored in the first memory module and then displays it on the display screen according to the identified personal feature.

### BACKGROUND OF THE INVENTION

1. Field of the Invention

This invention generally relates to a display device and a digital photograph displaying method. More particularly, this invention relates to a display device and a digital photograph displaying method for identifying a personal feature of a user to display a personalized digital photograph.

2. Description of the Prior Art

The progress of the display technology satisfies many people's desires in information technology. From small products such as a personal electronics to large products such as a computer monitor, a household appliance, or an advertisement board, etc., the display device is widely used in people's life. Furthermore, since digital cameras and photographable cell phones become more and more popular, a digital display device such as a digital frame is therefore developed.

A conventional digital frame reads digital information stored in a built-in memory, an external flash memory card, or an external video capturing device and shows the digital information with a static display or an animation display. However, the conventional digital frame lacks the ability to identify the user and the ability to show the digital information with a static display or an animation display in accordance with the user's preferences. Therefore, there is a desire to provide a personalized display device capable of displaying multimedia information based on user's preferences.

### SUMMARY OF THE INVENTION

It is an object of the present invention to provide a display device for displaying a digital photograph, wherein the display device is capable of identifying a personal feature of a user and displays a personal photo album in accordance with the personal feature to become a personalized display device.

It is another object of the present invention to provide a display device and a digital photograph displaying method for identifying personal features of different users to show digital information with a static display or an animation display in accordance with each user's preferences.

It is another object of the present invention to provide a display device and a digital photograph displaying method, wherein each user can customize the display shown on the display device based on his/her preferences.

The display device of the present invention includes a first memory module, an identification device, a display screen, and a processing module. The first memory module stores a plurality of multimedia information, which can be displayed on the display screen. The identification device has an identification interface, an identification capturing unit, and an identification processing module for receiving, capturing, and converting a personal feature into a personal identity code. The processing module is electrically coupled to the first memory module, the identification device, and the display screen. The processing module outputs the multimedia information corresponding to the personal feature so that the display screen displays the digital photograph together with the corresponding multimedia information. In a preferred embodiment, the identification device identifies a face feature, a fingerprint, or a voice. The personal feature identified by the identification device is converted into the personal identity code by using an algorithm, and the personal identity code is stored in an identification storage area of the identification device for further use.

This invention also provides a method for displaying a digital photograph together with multimedia information by a display device. The method includes collecting a personal feature, mapping the personal feature to one of a plurality of personal identity codes, and displaying the digital photograph together with one of a plurality multimedia information corresponding to the mapped personal identity code. The method further includes setting up a correlation table indicating the correlations between the plurality of personal identity codes and the plurality of multimedia information before the step of collecting the personal feature. The step of displaying the digital photograph includes displaying the digital photograph together with the corresponding multimedia information in accordance with the correlation table. The method further includes comparing the collected personal identity code with the plurality of personal identity codes to obtain the mapped personal identity code.

### BRIEF DESCRIPTION OF THE DRAWINGS

FIG. 1 is a schematic view of a preferred embodiment of a display device of the present invention;

FIG. 2 is a block diagram of a preferred embodiment of a display device of the present invention;

FIG. 3 is another block diagram of a preferred embodiment of a display device of the present invention;

FIG. 4a is a schematic view of a preferred embodiment of a display device of the present invention;

FIG. 4b is another schematic view of a preferred embodiment of a display device of the present invention; and

FIG. 5 is a flow chart of a displaying method of the present invention.

### DETAILED DESCRIPTION OF THE PREFERRED EMBODIMENT

The present invention provides a display device for displaying a digital photograph, wherein the display device displays multimedia information such as a personal photo album, drawings, etc. based on an identified personal feature of a user to become a personalized display device. The personal photo album described herein includes, but not limited to, a series of photographs pre-selected or pre-collected by a user, wherein any type of images and figures readable and displayable by the display device are included in the scope of the personal photo album described herein.

In a preferred embodiment, a user can select one of the series of photographs as a displayed page and sets the configurations of frame, music of condition, and the likes to make the display device become a personalized display device. Therefore, the display device and the digital photograph displaying method of the present invention allow the user to personalize displaying the digital photograph on the display device based on his or her preferences. Besides, the display device and the digital photograph displaying method of the present invention is preferably capable of identifying personal features of different users and showing static or animated digital information based on the user's preferences in response to the identification result. Therefore, in a preferred embodiment, the display device of the present invention further provides only some safety-concerned or encrypted information for a particular user based on the identification result.

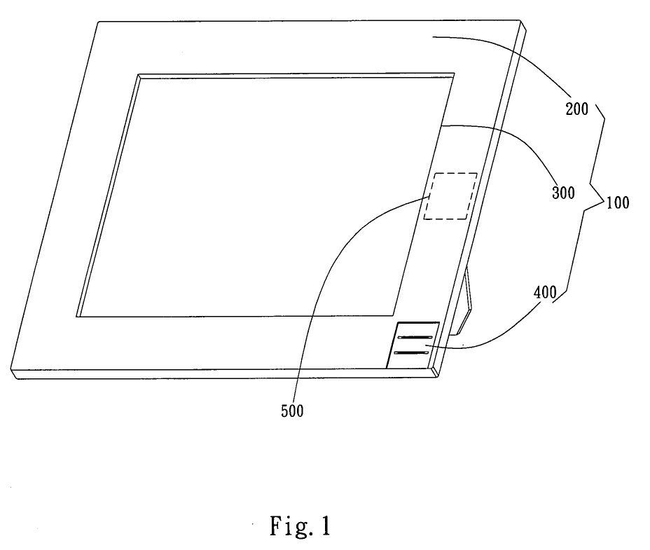

FIG. 1 shows a preferred embodiment of the present invention. As shown in FIG. 1, the display device 100 of the present invention includes a housing 200 and a display screen 300. The display screen 300 is disposed in the housing 200 and configured to display multimedia information, such as static images, animations, a streaming video, and a slideshow, and/or a digital photograph. The display screen 300 described herein preferably includes a thin film transistor liquid crystal display (TFT-LCD) panel. In other embodiments, however, the display screen 300 may be an organic light emitting diode (OLED) or other types of panels.

In a preferred embodiment shown in FIGS. 1-3, the display device 100 of the present invention includes an identification device 400, a memory module 500, and a processing module 600. The processing module 600 is electrically coupled to the first memory module 500, the identification device 400, and the display screen 300. In the preferred embodiment shown in FIG. 1, the identification device 400 is disposed at a corner of the housing 200 with respect to the display screen 300, but not limited to dispose at a corner of the housing 200. Furthermore, in other embodiments, the identification device 400 can be externally connected to the display screen 300 and the housing 200 and electrically coupled to the memory module 500 and the processing module 600 within the display device 100.

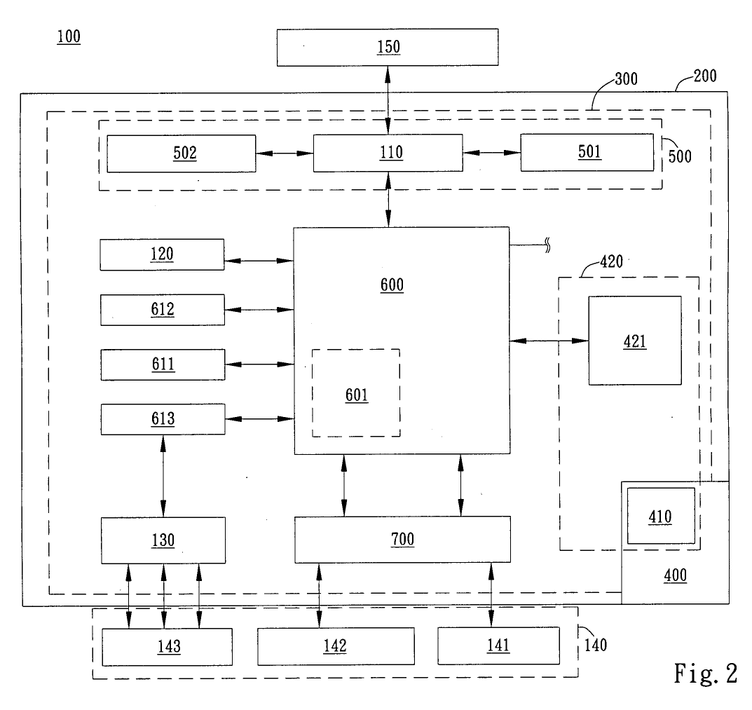

As shown in FIG. 2, the identification device 400 includes a feature capturing unit 410, an identification interface 420, and an identification processing module 421. The identification interface 420 is configured to provide an interface for receiving a personal feature. The feature capturing unit 410 is configured to capturing the personal feature of a user. The identification processing module 421 converts the personal feature into a personal identity code. For example, the process of identifying the personal feature includes the identification interface 420 receiving a biological feature of the user, the feature capturing unit 410 sensing the biological feature, and the identification processing module 421 converting the biological feature into the personal identity code. In one embodiment, the biological feature includes, but not limited to, face features, fingerprints, voice, iris patterns, and any body's unique biological feature.

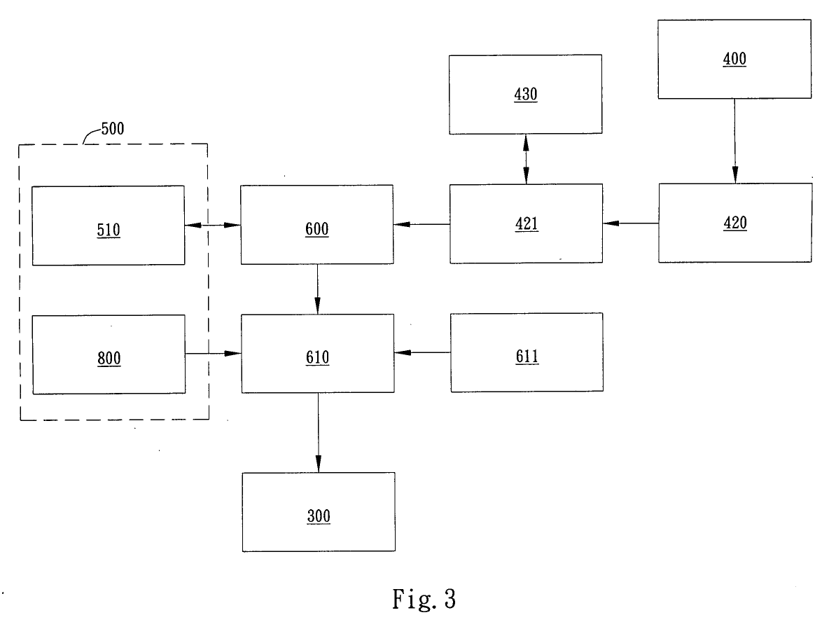

As shown in FIG. 2 and FIG. 3, the identification device 400 preferably further includes an identification storage area 430 for storing the personal identity code. The personal identity code described herein can be a program code representing a specific person. The program code is obtained by capturing and identifying the biological feature to form a specific image or picture, and then using an algorithm together with various parameters to convert the biological feature into a code. Taking fingerprint identification as an example, after the identification interface 420 receiving the fingerprint and the feature capturing unit 410 capturing the received fingerprint to form a fingerprint image, the identification processing module 421 processes the fingerprint image by using an algorithm and converts the fingerprint image into a personal identity code of the fingerprint. The personal identity code of fingerprint is then stored in the identification storage area 430 for use in identifying a person based on the fingerprint in the future. The above embodiment is merely an example for explaining how the identification device 400 operates to convert a biological feature into a personal identity code, and the scope of the present invention is not limited thereto. In other embodiments, the identification device 400 may includes more or less components to perform less or more functions to achieve a similar result.

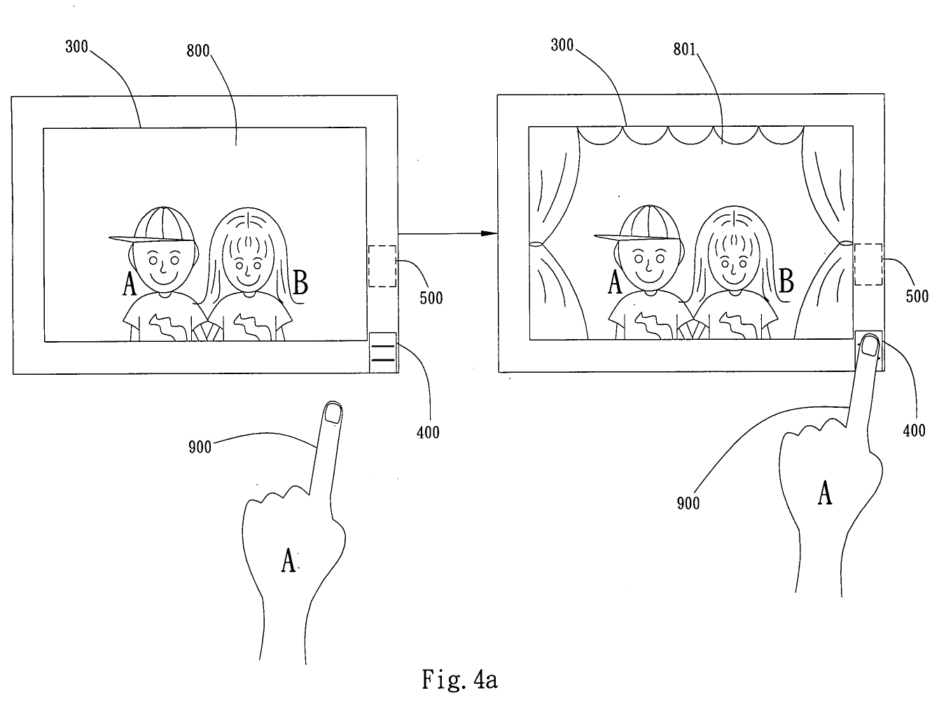

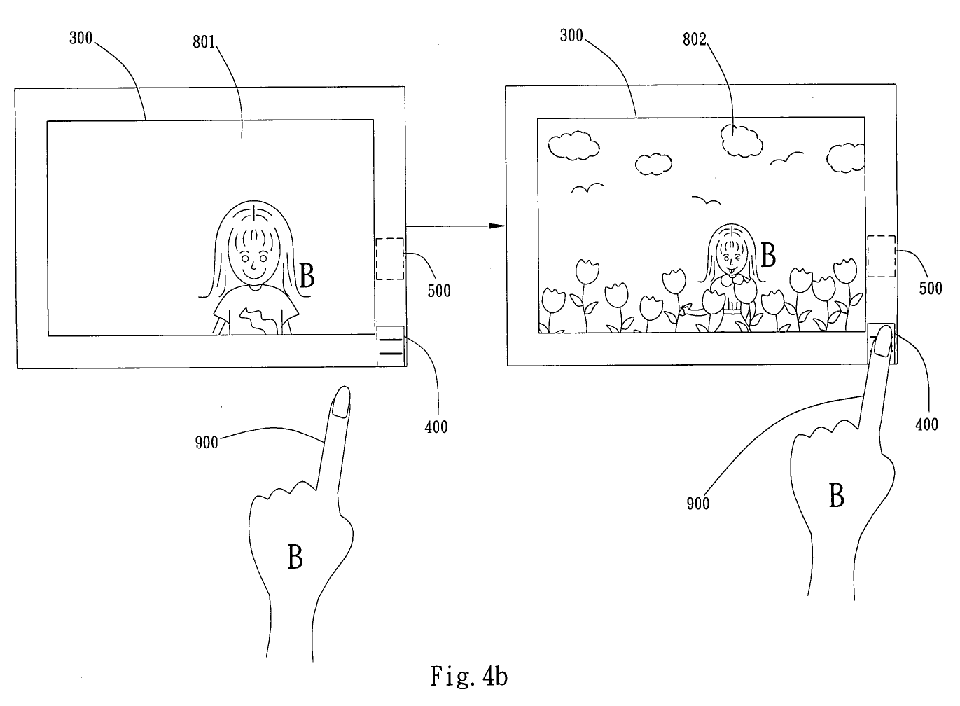

As shown in FIG. 2 and FIG. 3, the memory module 500 stores multimedia information 800 (see FIG. 4a) and is electrically coupled to the processing module 600 through a memory controller 110. The memory module 500 is preferably built in the display device 100 and includes a ROM, a DRAM, or a FLASH memory, etc. In other embodiments, however, the memory module 500 may include an external storage device 150 electrically coupled to the memory controller 110. Therefore, the processing module 600 can access at least a part of the multimedia information 800 from the external storage device 150 and then display it on the display screen 300. The external storage device 150 includes an external hard drive or an external memory card, such as an SD card, a MMC card, a CF card, and the likes.

As shown in FIG. 2 and FIG. 3, the memory module 500 preferably includes a first memory module 501 and a second memory module 502. Please note that the first memory module 501 and the second memory module 502 can be integrated as a single memory module or two separate memory modules. The first memory module 501 stores a plurality of multimedia information and the second memory module 502 stores the personal identity code. For example, the first memory module 501 stores the multimedia information including at least a first multimedia information 801 and a second multimedia information 802 (see FIG. 4a and FIG. 4b), and the second memory module 502 stores the personal identity code including a first personal identity code and a second personal identity code together with a correlation table. The correlation table is a table indicating the correlations between the multimedia information and the personal identity codes converted from the personal feature by the identification device 400. For example, the correlation table indicates the correlations between the first multimedia information 801 and the first personal identity code and between the second multimedia information 802 and the second identity code. Therefore, when the identified personal identity code conforms to the first personal identity code, the display screen 300 displays the first multimedia information 801 in accordance with the correlation table, and when the identified personal identity code conforms to the second personal identity code, the display screen 300 displays the second multimedia information 802 in accordance with the correlation table.

In the embodiment shown in FIG. 2 and FIG. 3, the processing module 600 is electrically coupled to the memory module 500, the identification device 400, and the display screen 300, and preferably loads at least a part of the multimedia information 800 from the memory module 500 in accordance with the personal identity code generated by the identification device 400 to display the loaded multimedia information 800 on the display screen 300. As shown in FIG. 2, the processing module 600 is preferably, but not limited to, a direct memory access controller for accelerating the data access and the algorithm conversion. In other embodiments, the processing module 600 includes a modular calculating unit consisting of a reduced instruction set computing (RISC) microprocessor 601, such as an ultra high speed 32 bits RISC microprocessor, for accelerating the data access and the algorithm conversion.

In the embodiment shown in FIG. 3, the processing module 600 sets up a correlation between a personal parameter and a personal identity code, and the memory module 500 further includes a personal parameter storage area 510 for storing the personal parameters. The personal parameters mentioned herein include, but not limited to, the storage location of the multimedia information 800 in the memory module 500, the displaying mode of the multimedia information 800 on the display screen 300, or other customized parameters. In a preferred embodiment, the processing module 600 provides a setup interface for setting up the correlation table indicating the correlations between the first personal identity code and the first multimedia information and between the second personal identity code and the second multimedia information. Therefore, the processing module 600 can output the multimedia information to the display screen 300 in accordance with the personal feature. Furthermore, in the embodiment shown in FIG. 2, the display device 100 further includes an input device 141 electrically coupled to the processing module 600. The input device 141 is provided for setting up the correlation table which indicates the correlations between the first personal identity code and the first multimedia information and between the second personal identity code and the second multimedia information.

As shown in FIG. 2 and FIG. 3, the processing module 600 preferably further includes a displaying module 613. When the processing module 600 receives the personal identity code, the displaying module 613 accesses the personal parameters and loads at least a part of the multimedia information 800 from the first memory module 501 to be displayed on the display screen 300. In the preferred embodiment, the displaying module 613 can be implemented with softwares or hardwares, such as a graphic card, a graphic chip set, and a driving integrated circuit (IC). In other embodiments, however, the displaying module 613 preferably includes displaying softwares for optimizing multimedia information by using a graphic algorithm.

In the embodiment shown in FIG. 2, the processing module 600 further includes a special effect module 611 and a sound effect module 612, which are electrically coupled to the processing module 600 respectively. In a preferred embodiment, the special effect module 611 is configured to adjust the display effect of the first multimedia information or the second multimedia information. The display effect refers to various modular display effects or figures included in the special effect module 611, which can be selected based on the user's preferences and shown on the display device to visually enhance the display on the display screen 300. Furthermore, the sound effect module 612 is preferably an audio output device, such as a speaker or an audio output port provided for connecting an external audio output device, so that sound information stored in the first memory module 501 can be played. The sound information can be stored in a format including MP3, wav, or other suitable formats. Therefore, the sound effect module 612 can play an audio file when the multimedia information 800 is being showed, or play an audio file in accordance with the sound information outputted by the processing module 600 based on the personal feature. With reference to FIG. 4a and FIG. 4b, how the display device of the present invention identifies a personal feature and outputs corresponding multimedia information 800 will be described below.

As shown in FIG. 4a, the display screen 300 shows multimedia information, such as a digital photograph, when no personal feature 900 is detected. When a user A puts a finger on the identification device 400 to provide a personal feature, such as a fingerprint, the identification device 400 senses the fingerprint of the user A and converts the fingerprint of the user A into a personal identity code. Then, the user A's personal identity code is compared with the personal identity codes stored in the second memory module 502. When the user A's fingerprint (i.e. the user A's personal identity code) matches one of the stored personal identity codes, e.g. the first user personal identity code, the processing module 600 accesses the first multimedia information 801 in the first memory module 501 and shows the first multimedia information 801 together with the digital picture on the display screen 300. In another embodiment shown in FIG. 4b, when a user B puts a finger on the identification device 400 to provide the biological feature, e.g. the fingerprint, the identification device 400 senses the fingerprint of the user B, converts the fingerprint of the user B, and compares it with the personal identity codes stored in the second memory module 502. When the user B's fingerprint matches with the second user personal identity code, the processing module 600 accesses the second multimedia information 802 in the first memory module 501 to display the second multimedia information 802 in place of the first multimedia information 801 on the display screen 300.

In order to operate the display device of the present invention more conveniently, in other embodiments, the display device 100 further includes a user interface module for a user to modify the multimedia information 800 shown on the display screen 300 when loading the multimedia information 800 into the processing module 600 from the memory module 500. The user interface module described herein includes a function can be activated by the user by remote controlling, touching a screen, or pressing a button on the housing 200, so that the display on the display screen 300 can be customized to meet personal requirements. In the embodiment shown in FIG. 2, the display device 100 further includes a signal input device 700 for receiving external multimedia information and allowing the user to store the external multimedia information in the memory module 500. The signal input device 700 is preferably but not limited to a universal series bus (USB) port or any suitable connection port capable of communicating with external devices so as to show digital information stored therein on the displaying screen 300. In other embodiments, the signal input device 700 can electrically coupled to an external picture capturing device (such as a digital camera or a photographing cell phone), an external device (such as a personal computer or a laptop computer), or a displaying device (such as a television or a liquid crystal display monitor) to exchange and process the multimedia information.

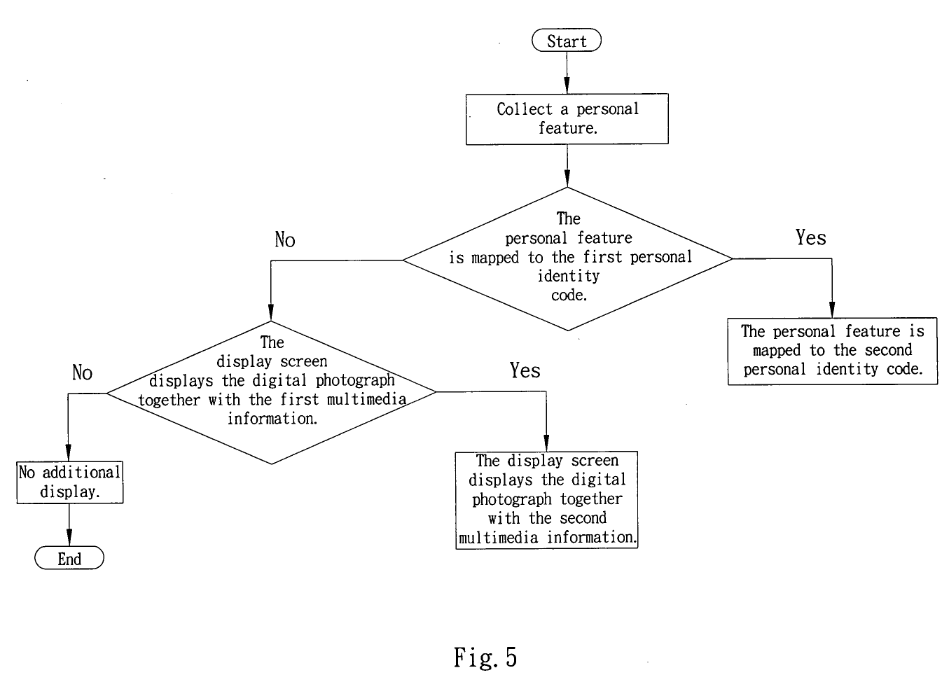

The present invention also provides a method for displaying a digital photograph together with multimedia information by a display device. The display device includes a display screen and a memory module for storing a plurality of multimedia information and a plurality of personal identity codes. For example, the display device can be the display device 100 shown in FIG. 2 or FIG. 3. FIG. 5 shows a flow chart of a displaying method in accordance with one embodiment of the present invention. As shown in FIG. 5, the method includes the steps of receiving a personal feature, mapping the feature to one of the plurality of personal identity codes, displaying the digital photograph together with one of the plurality of multimedia information, which corresponds to the mapped personal identity code. For example, when the received personal feature is mapped to the first personal identity code, the first multimedia information together with the digital photograph is displayed. When the received personal feature is mapped to the second personal identity code, the digital photograph together with the second multimedia information is displayed. When the displaying method is implemented by the display devices 100 of FIG. 1, the step of collecting the personal feature further includes converting the personal feature into a collected personal identity code by using an algorithm, wherein the personal feature is obtained by sensing the biological feature of the user by using an identification device to identify a face feature, a fingerprint, or a voice. The personal identity code described herein is a program code representing a specific person. The program code is obtained by sampling and identifying the biological feature to form a specific image or picture, and then using an algorithm together with various parameters to convert the biological feature into a code. Take face identification as an example, after the identification interface 420 sensing a user's face and the feature capturing unit 410 capturing the sensed face image, the identification processing module 421 processes the face image by using an algorithm and converts the face image into a personal identity code of the user's face. The personal identity code of face is then stored in the identification storage area 430 for use in identifying a personal of the face in the future.

When the displaying method is implemented by the display devices 100 of FIG. 1, the step of collecting the personal feature further includes using a direct memory access controller as a processing module to receive the personal identity code. In other embodiments, the processing module 600 includes a modular calculating unit consisting of a reduced instruction set computing (RISC) microprocessor 601, such as an ultra high speed 32 bits RISC microprocessor, for accelerating the data access and the algorithm conversion. Furthermore, the step of mapping the personal feature includes comparing the collected personal identity code with the plurality of personal identity codes to obtain the mapped personal identity code. The display device includes the processing module, and the memory modules can store a correlation table. Therefore, the method further includes setting up the correlation table indicating the correlations between the plurality of personal identity codes and the plurality of multimedia information before the step of collecting the personal feature. The step of displaying the digital photograph includes displaying the digital photograph together with the corresponding multimedia information in accordance with the correlation table.

Furthermore, the method includes mapping the personal feature to one of the plurality of personal identity codes, and displaying the digital photograph together with one of the plurality multimedia information corresponding to the mapped personal identity code. In a preferred embodiment, the method further includes setting up a personal information storage area for storing the personal parameters accessed by the processing module. The personal parameters mentioned herein include, but not limited to, the storage location of multimedia information in the memory module, the displaying mode of multimedia information 800 on the display screen, or other customized parameters.

For providing the user more customized options, the digital photograph displaying step further includes accessing a displaying module for adjusting the display effect of the multimedia information displayed on the display device. When the displaying method is implemented by the display devices 100 of FIG. 1, since the display device includes a special effect module, the method further includes using the special effect module to adjust the display effect of the first multimedia information or the second multimedia information. In a preferred embodiment, the digital photograph displaying step further includes accessing a special effect module electrically coupled to the processing module. When the personal identity code is provided to the processing module, the processing module works with the special effect module to load the multimedia information and to show a personalized information display on the display device. In order to operate the display device of the present invention more conveniently, the method further includes accessing a user interface module before the personal feature collecting step for modifying the multimedia information shown on the display screen by remote controlling, touching a screen, or pressing a button on the housing. As mentioned above, a user can set the personal parameters, such as configurations of displaying frame, music of condition, and the likes, to show multimedia information as a static image, an animation, a slideshow, or the likes to satisfy the demand of a personalized digital display device.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display device for displaying a digital photograph, the display device comprising:
a first memory module for storing a plurality of multimedia information;
an identification device for identifying a personal feature to correspond to one of the plurality of multimedia information;
a display screen; and
a processing module electrically coupled to the first memory module, the identification device, and the display screen, wherein the processing module outputs the corresponding multimedia information so that the display screen displays the digital photograph together with the corresponding multimedia information.

2. The display device of claim 1, wherein the identification device further includes an identification processing module and an identification interface, wherein the identification processing module converts the personal feature into a personal identity code via the identification interface.

3. The display device of claim 2, wherein the multimedia information includes a first multimedia information and a second multimedia information, and the display device further comprises:
a second memory module for storing a first personal identity code, a second personal identity code, and a correlation table,
wherein the display screen displays the first multimedia information in accordance with the correlation table when the personal identity code conforms to the first personal identity code, and the display screen displays the second multimedia information in accordance with the correlation table when the personal identity code conforms to the second personal identity code.

4. The display device of claim 3, wherein the processing module provides a setup interface for setting up the correlation table indicating the correlations between the first personal identity code and the first multimedia information and between the second personal identity code and the second multimedia information.

5. The display device of claim 3, further comprising:
an input device electrically coupled to the processing module, wherein the input device is provided for setting up the correlation table indicating the correlations between the first personal identity code and the first multimedia information and between the second personal identity code and the second multimedia information.

6. The display device of claim 3, wherein the processing module further includes a special effect module for adjusting the display effect of the first multimedia information or the second multimedia information.

7. The display device of claim 1, wherein the first memory module further stores a sound effect information, the processing module further includes a sound effect module for outputting a sound effect in accordance with the sound effect information.

8. The display device of claim 1, wherein the identification device identifies the personal feature including a biological feature.

9. The display device of claim 8, wherein the biological feature includes a fingerprint, a human voice, iris pattern, or a face feature.

10. A method for displaying a digital photograph together with multimedia information by a display device, wherein the display device includes a display screen and a memory module for storing a plurality of multimedia information and a plurality of personal identity codes, the method comprising:
collecting a personal feature;
mapping the personal feature to one of the plurality of personal identity codes; and
displaying the digital photograph together with one of the plurality multimedia information corresponding to the mapped personal identity code.

11. The method of claim 10, wherein the step of collecting the personal feature further includes converting the personal feature into a collected personal identity code by using an algorithm.

12. The method of claim 11, wherein the step of mapping the personal feature comprises comparing the collected personal identity code with the plurality of personal identity codes to obtain the mapped personal identity code.

13. The method of claim 10, further comprising:
setting up a correlation table indicating the correlations between the plurality of personal identity codes and the plurality of multimedia information before the step of collecting the personal feature,
wherein the step of displaying the digital photograph comprises displaying the digital photograph together with the corresponding multimedia information in accordance with the correlation table.

14. The method of claim 10, wherein the display device further includes a special effect module, and the method further comprises:
adjusting the display effect of the multimedia information displayed on the display device.
